(19) United States
(12) Patent Application Publication
(10) Pub. No.: US 2024/0062064 A1
(43) Pub. Date: Feb. 22, 2024

(54) Artificial Intelligence Computing Systems for Efficiently Learning Underlying Features of Data

(71) Applicant: Mindtrace.ai USA, Inc., Coto De Caza, CA (US)

(72) Inventors: Milos Puzovic, Manchester (GB); Jeremy Wurbs, College Station, TX (US)

(73) Assignee: Mindtrace.ai USA, Inc., Coto De Caza, CA (US)

(21) Appl. No.: 17/889,738

(22) Filed: Aug. 17, 2022

(51) Int. Cl. G06N 3/08; G06V 10/774

(52) U.S. Cl. CPC G06N 3/082; G06V 10/7753

(57) ABSTRACT

A computing system includes a processor that executes program instructions and memory for storing the program instructions. The program instructions include an artificial neural network (ANN) that receives input data. The ANN maps the input data to a latent representation of the input data. The ANN maps the latent representation of the input data to a reconstruction of the input data. The computing system adapts learning features of an artificial intelligence model based on an output of the ANN.

### FIELD OF THE DISCLOSURE

The present disclosure relates to artificial intelligence computing systems, and more particularly, to artificial intelligence computing systems that efficiently learn underlying features of data.

### BACKGROUND

An artificial neural network (ANN) is a collection of connected nodes that is implemented by a computer system. An ANN loosely models the neurons in a biological brain. A node in an ANN receives and processes an input signal from one or more nodes and transmits an output signal to other nodes in the network. The input signal at each node represents a real number, and the output of each node is computed as a function of the sum of the input signals to the node. The connections between nodes are referred to as edges. Edges are typically associated with weights that adjust as learning proceeds. A weight increases or decreases the strength of the signal at a connection. Each of the nodes may have a threshold such that the node only generates an output signal if the computed output of the node crosses the threshold. Typically, the nodes in an ANN are organized into layers. Each of the layers may perform a different function on its input signals. Signals travel through the layers to the output of the ANN.

### BRIEF DESCRIPTION OF THE DRAWINGS

FIG. 1 is a flow diagram that illustrates an example of an artificial intelligence (AI) system that amends a pre-trained model using unlabeled data, according to an embodiment.

FIG. 2 is a flow diagram that illustrates how the AI system of FIG. 1 can be trained during a supervised learning process to improve the accuracy of the output data, according to an embodiment.

FIG. 3 is a flow diagram for an AI system that uses learnt data augmentation and supervised training to improve the performance of an AI model, according to another embodiment.

FIG. 4 is a flow diagram for an artificial intelligence (AI) system that includes a backbone model, a teacher model, and a student model that learns from the teacher model, according to another embodiment.

FIG. 5 illustrates an artificial intelligence (AI) system that can implement various embodiments disclosed herein, for example, with respect to FIGS. 1-4.

### DETAILED DESCRIPTION

Conventional artificial neural networks (ANNs) typically require training from labeled data in order to perform classification and other supervised learning tasks, such as taking an input image and assigning a class label to the image. Unsupervised learning techniques can be used to train ANNs without data labels. Self-supervised learning techniques can be used to train ANNs using a mix of data with and without data labels, such that data labels are internally generated by the network during training from unlabeled data. One type of ANN trained in this manner is referred to as an autoencoder.

An autoencoder is a type of unsupervised artificial neural network that receives input data and learns how to replicate the input data. An autoencoder encodes and then decodes the input data in an unsupervised fashion to make the reconstructed data as close as possible to the input data. The goal of an autoencoder is to learn an inherent representation (i.e., an encoding) of the input data that has useful properties for reconstructing the input data, for example, using dimensionality reduction, by training the ANN to ignore signal noise.

An autoencoder typically includes an encoder and a decoder. The encoder has encoding layers that map the input data to a latent representation of the input data. As an example, the encoder may compress the input data to generate a compressed representation of the input data that has reduced dimensionality compared to the input data. The encoder may determine which aspects of the input data are to be preserved and which aspects of the input data are to be discarded to generate the compressed representation of the input data that can be faithfully reconstructed to regenerate the input data. An autoencoder may choose the output of the final hidden unit to have a smaller number of dimensions than the input data, which creates a bottleneck that forces the neural network in the autoencoder to learn a compact representation of the data. The encoder may determine the features of the input data that are most important for reconstructing the input data, for example, using element-wise activation on the weights and biases of the network. The decoder maps the latent representation of the input data generated by the encoder to a reconstruction of the input data. The autoencoder then compares this reconstruction of the input data to the original input data to determine the accuracy of the features of the latent representation selected to reconstruct the input data.

Autoencoders have been used to circumvent the need for explicit data labelling. However, autoencoders are typically unable to perform inference tasks directly, such as classification. Instead, a supervised learning phase may be added to an already trained ANN in order to generate an ANN that can perform inference tasks, such as classification. After the supervised learning phase is complete, the ANN cannot be then further fined tuned using supervised or self-supervised techniques without forgetting the knowledge that has been gained through training. This problem is referred to as catastrophic forgetting.

Conventional artificial intelligence (AI) architectures are often deployed as static models that use a lengthy pre-deployment training process with large amounts of labeled data to provide analytics intelligence for end users once deployed. These architectures, however, are not able to adapt to the user's specific use-case post-deployment without extensive data collection and re-training. Few-shot methods have been provided that alleviate the lengthy training constraint, but these methods commonly exhibit catastrophic forgetting.

According to some embodiments disclosed herein, an artificial intelligence (AI) computing system includes a processor that executes program instructions and a memory for storing the program instructions. The program instructions include an ANN. The ANN receives input data, maps the input data to a latent representation of the input data, and maps the latent representation of the input data to a reconstruction of the input data. The artificial intelligence computing system adapts learning features of an ANN model based on learning techniques disclosed herein. As an example, the AI computing system may use semi-supervised learning techniques in a modular architecture to adapt learning features of a pre-trained (e.g., big data) artificial neural network (ANN). After being adapted, the pre-trained ANN may be able to run identically to the original ANN, without any loss in accuracy or performance. The AI computing system may incorporate few-shot learning modules that enable the ANN to adapt post-deployment without lengthy additional training. The AI computing system may, for example, introduce enhanced learning capabilities by simultaneously using semi-supervised and unsupervised learning on a latent representation generated by various ANNs in order to address catastrophic forgetting.

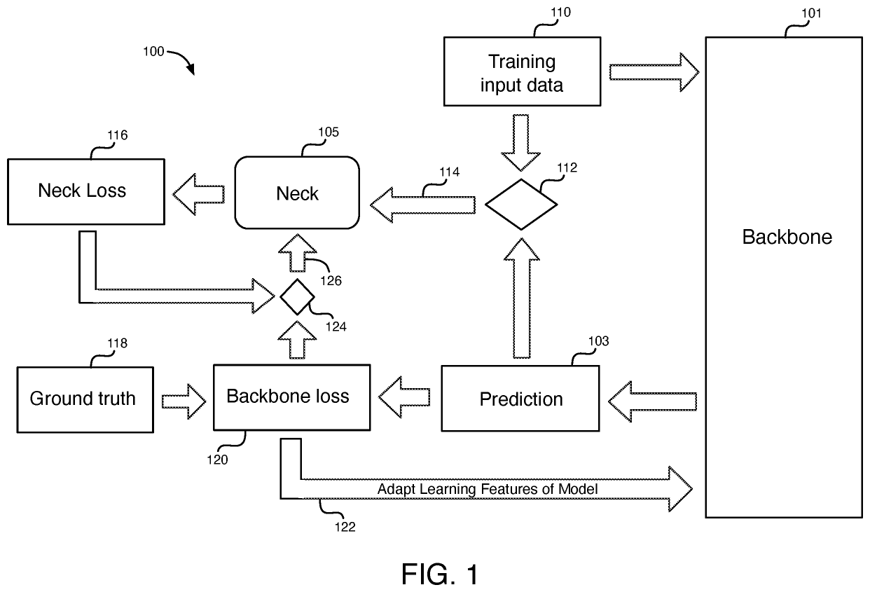

Figure (FIG.) 1 is a flow diagram that illustrates how an artificial intelligence (AI) computing system 100 can be trained during a self-supervised learning process to improve the accuracy of the output data, according to an embodiment. The AI computing system 100 (also referred to herein as AI system 100) of FIG. 1 includes a backbone model 101 (also referred to herein as backbone 101). Backbone model 101 may be an artificial neural network (ANN) or another type of AI model, including another type of machine learning algorithm. AI computing system 100 also includes a neck model 105 (also referred to herein as neck 105). Neck model 105 may include, for example, an artificial neural network (ANN) such as an autoencoder, or another type of AI model, including another type of machine learning algorithm.

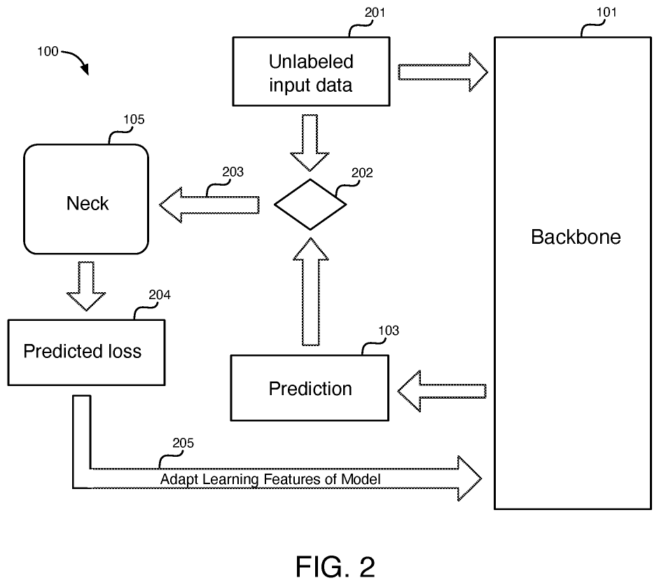

AI system 100 can be used to train a backbone model 101 using neck model 105 and training input data 110 during a first stage. During the first stage disclosed herein with respect to FIG. 1, the backbone model 101 is trained using only training input data 110. The training input data 110 may be labeled data containing labels that identify characteristics in the training input data 110. For example, the training input data 110 may contain images and labels that identify the images. During a second stage disclosed herein in further detail with respect to FIG. 2, the neck model 105 supervises the learning process of the backbone model 101 on an unlabeled data set in order to improve the performance of the backbone model 101. After the first stage, the neck model 105 learns how well the backbone model 101 generalizes using training data. These two objective functions are optimized using a min-max optimization as shown in the equation below, wherein y is the ground truth.

$${min}_{{θ}_{N}} {max}_{{θ}_{B}} ℒ ( {θ}_{N} , {θ}_{B} ) = {E}_{x} \vert {ℒ}_{N} ( N ( x ) , x ) - {ℒ}_{B} ( B ( x ) , y ) \vert + {E}_{x} \vert {ℒ}_{B} ( B ( x ) , y ) \vert$$

In the embodiment of FIG. 1, the backbone model 101 is initially pre-trained during the training phase with training input data 110 during a supervised learning process to perform a task with some accuracy. The backbone model 101 processes the training input data 110 to generate a prediction 103. The backbone model 101 may be trained using supervised learning techniques, for example, by determining the difference between the prediction 103 and a ground truth 118.

Ground truth 118 is the expected outcome of the input when the input is processed by an ANN. The ground truth 118 may be, for example, identified by labels used to categorize the training input data 110. As an example for classification, if the input image is an image of a fox, then ground truth 118 is the fox. As an example for segmentation, if the ANN is attempting to segment out a person in an image, then the ground truth 118 is a mask that shows which pixels in the image belong to the person.

Ground truth 118 is compared to the prediction 103 generated by the backbone model 101 to generate a backbone loss 120 for the backbone model 101. The backbone loss 120 may, for example, indicate the difference between the prediction 103 and the ground truth 118. The backbone loss 120 indicates the accuracy of the prediction 103 and the accuracy of the current configuration of the backbone model 101 relative to the ground truth 118. The backbone loss 120 is then provided to the backbone model 101 in operation 122 to adapt learning features of the backbone model 101 without performance loss in the backbone model 101. As an example, the backbone loss 120 may be used to adjust the weights of an ANN in backbone model 101 and/or optional thresholds of the ANN in the backbone model 101 according to a learning rule. In this example, successive adjustments to the weights and/or thresholds of the ANN cause the backbone model 101 to produce a prediction 103 that is increasingly similar to the ground truth 118 during the supervising learning process.

In some embodiments, the backbone model 101 can be trained using AI system 100 as disclosed herein with respect to FIG. 1 prior to processing unlabeled input data, as disclosed herein with respect to FIG. 2. During the training phase of FIG. 1, AI system 100 uses the labeled training data 110 with a prediction 103 generated by the backbone model 101 to cause the neck model 105 to start learning an error (i.e., the neck loss 116) in response to processing the prediction 103 and the training data 110.

In AI computing system 100, the backbone model 101 processes the training input data 110 using, for example, an ANN or other AI model to generate the prediction 103. The prediction 103 is combined with the training input data 110 in operation 112 to generate concatenated input data. The concatenated input data is provided to the neck model 105 in operation 114. Neck model 105 generates a latent representation of the concatenated input data using, for example, an autoencoder. The latent representation generated by the autoencoder is used to identify a neck loss 116.

The backbone loss 120 is combined with the neck loss 116 generated by the neck model 105 at operation 124 and then provided to the neck model 105. The backbone loss 120 and the neck loss 116 are used to adapt learning features of the neck model 105 in operation 126. As an example, the backbone loss 120 and the neck loss 116 may be used to update the weights, and any optional thresholds, in the autoencoder in neck model 105. In some embodiments, after the supervised training phase of AI system 100 is complete, AI system 100 performs unsupervised training as disclosed herein with respect to FIG. 2 to make further adjustments to the backbone model 101.

FIG. 2 is a flow diagram that illustrates an example of how the artificial intelligence (AI) computing system 100 of FIG. 1 amends the backbone model 101 using unlabeled input data after the backbone model 101 has been pre-trained using the techniques of FIG. 1, according to an embodiment. AI computing system 100 includes the backbone model 101 and the neck model 105. Backbone model 101 of FIG. 2 has been pre-trained using the techniques disclosed herein with respect to FIG. 1.

A pre-trained ANN may generate an accurate prediction using unlabeled input data that is similar to the labeled training input data that was used to train the ANN during the supervised learning process. However, often a pre-trained ANN generates a less accurate prediction using unlabeled input data that is less similar in at least one characteristic to the labeled training input data that was used to train the ANN.

The accuracy of a pre-trained ANN for processing unlabeled input data may be improved by providing additional supervised training to the ANN using a large amount of additional labeled input data that is similar to the test input data. However, it is typically expensive and time consuming to generate a large amount of labeled input data to improve the accuracy of a pre-trained ANN. For example, a large amount of images may need to be manually tagged to generate labeled input images. The process of manually labeling a large amount of image data may be costly and time consuming. Therefore, it would be desirable to provide an AI system that has been pre-trained with labeled input data during a supervising learning process (i.e., a backbone) and then use unlabeled input data that may or may not be similar to the labeled input data to improve the AI system.

In the embodiment of FIG. 2, AI computing system 100 includes the neck model 105. The neck model 105 includes an ANN or other type of AI model that leverages unlabeled data to improve the accuracy of a pre-trained ANN or other type of AI model in backbone model 101. The neck model 105 may, for example, include an autoencoder. Neck model 105 allows the backbone model 101 to process unlabeled input data 201 with improved accuracy, without requiring additional supervised training of the backbone model 101 with additional labeled input data. The unlabeled input data 201 may or may not be different in at least one characteristic than the training input data 110 used to train backbone model 101.

Referring to FIG. 2, unlabeled input data 201 is provided to the pre-trained backbone model 101 (e.g., a pre-trained ANN). Backbone model 101 has been pre-trained to output a prediction 103 based on the unlabeled input data 201. The prediction 103 may be, for example, one or more classifications of the unlabeled input data 201 or one or more pixel-wise segmentations of objects present in images in the unlabeled input data 201.

At operation 202, the AI computing system 100 concatenates the unlabeled input data 201 and the prediction 103 output by the backbone model 101 to generate concatenated input data. The concatenated input data is provided to the neck model 105 at operation 203. The neck model 105 processes the concatenated input data that includes the unlabeled input data 201 and the prediction 103 to generate a predicted loss 204. The predicted loss 204 indicates information about the concatenated input data to the neck model 105 that included the unlabeled input data 201 and the prediction 103. For example, the predicted loss 204 may indicate one or more errors in the prediction 103 that was made by the backbone model 101. The predicted loss 204 includes one or more values that are used in operation 205 to adapt learning features of the backbone model 101.

As an example, the neck model 105 may include an autoencoder that processes the concatenated input data that includes the unlabeled input data 201 and the prediction 103 to generate the predicted loss 204. The autoencoder may include an encoder and a decoder. The encoder maps the concatenated input data to a latent representation that represents features of the concatenated input data that can be used to reconstruct the concatenated input data. The encoder may, for example, reduce the dimensionality of the concatenated input data to generate the latent representation having reduced dimensions compared to the concatenated input data. The encoder causes the latent representation of the concatenated input data to have features that can be decoded by the decoder to accurately reconstruct the concatenated input data. For example, the encoder may generate a latent representation having features of the concatenated input data that are most important for finding the error between prediction 103 and ground truth 118.

The decoder in the autoencoder maps the latent representation of the input data generated by the encoder to a reconstruction of the concatenated input data that is as close as possible to the concatenated input data. The autoencoder adapts weights and/or thresholds of the ANN in neck model 105 and the resulting latent representation until the reconstruction of the concatenated input data generated by the decoder is as close as possible to the concatenated input data originally provided to the encoder in operation 203. The neck model 105 may provide the latent representation of the concatenated input data or features of the latent representation generated by the encoder as the predicted loss 204. The neck model 105 may provide the reconstruction of the concatenated input data generated by the decoder as the predicted loss 204 or a portion thereof, in addition to, or instead of, the latent representation.

As a more specific example, an autoencoder in neck model 105 may include an encoder that compresses the concatenated input data to generate a compressed representation of the concatenated input data that has reduced dimensionality. The decoder then decompress the compressed representation of the concatenated input data to reconstruct the concatenated input data. In this example, the compressed representation or features of the compressed representation of the concatenated input data may be provided to the output of the neck 105 as the predicted loss 204.

The predicted loss 204 generated by neck model 105 is then provided to the backbone model 101 in operation 205 to adapt the learning features of the AI model in the backbone model 101 without performance loss in the backbone model 101. As an example, the predicted loss 204 may be used to adjust the weights of an ANN and/or optional thresholds of the ANN in the backbone model 101. As another example, the predicted loss 204 may be used to eliminate nodes in the backbone model 101. The backbone model 101 may, for example, use the predicted loss 204 for the purpose of classification, detection, or segmentation of unlabeled input data. The process disclosed herein with respect to FIG. 2 may be performed iteratively to cause the backbone model 101 to more accurately identify the prediction 103 in the unlabeled input data 201.

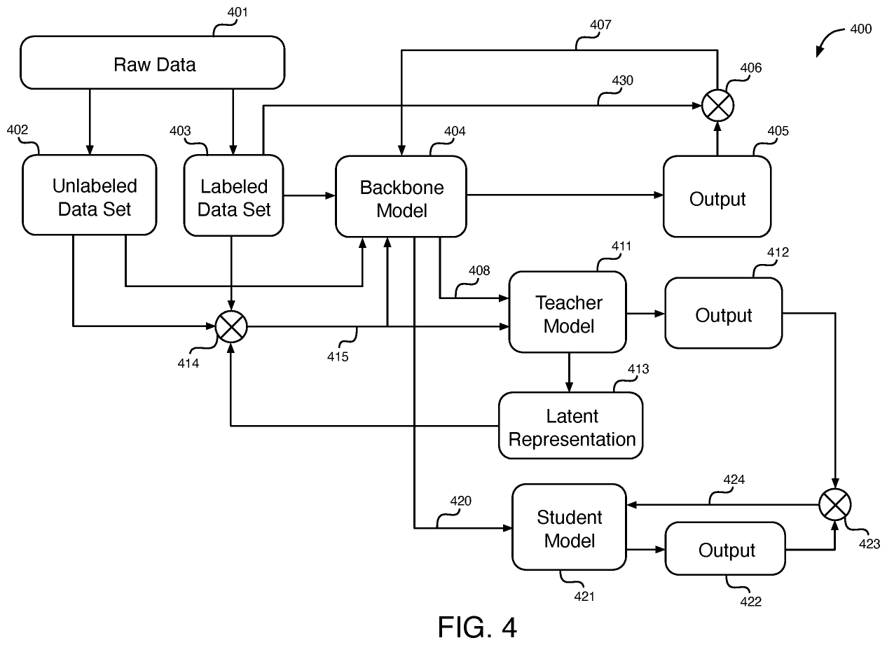

In the embodiment of FIG. 2, the backbone model 101 may be a teacher model, and the neck model 105 may be a student model that learns from the output of the teacher model, as disclosed herein in more detail with respect to FIG. 4. At the end of each iteration of the process of FIG. 2, a teacher model can be replaced with a student model in the subsequent iteration such that the model architecture of backbone model 101 will be from neck model 105.

The AI computing system 100 of FIGS. 1-2 may be used for pre-deployment and/or post-deployment training utilizing of the unlabeled input data 201. Pre-deployment training occurs when the backbone model 101 has access to the labeled input data 110 that the backbone model 101 was trained with, but higher accuracy is requested than what is being obtained using classical supervised training. Post-deployment training occurs when the backbone model 101 does not generate accurate predictions using new unlabeled input data that is significantly different than the training input data 110 that the backbone model 101 was trained with. The AI computing system 100 can significantly improve the accuracy of the prediction 103 using pre-deployment and post-deployment training compared to previously known solutions. As a specific example that is not intended to be limiting, AI computing system 100 can be used in a post-deployment training environment in which the unlabeled input data 201 is taken from an end-user video feed in order to train the autoencoder in neck model 105 to code for specific features present in the end-user scenario that were not present in the training input data used to train backbone model 101.

According to other embodiments, an AI architecture is provided that utilizes disentangled latent object representations to allow for enhanced learning capabilities, both pre-deployment and post-deployment. These embodiments allow for unlabeled input data to be used to improve the accuracy of an AI system for inference tasks, such as classification or detection. Using this architecture, semi-supervised and unlabeled data training may be interleaved together in any order, indefinitely, without the AI system experiencing catastrophic forgetting. This architecture can be used to train an AI system how to improve the accuracy of the AI system with a large amount of unlabeled input data.

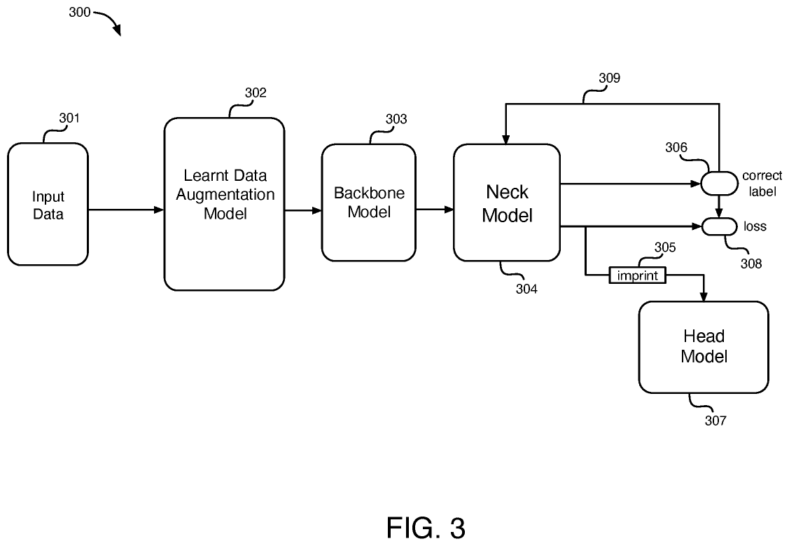

FIG. 3 is a flow diagram for an artificial intelligence (AI) computing system 300 that shows how to use data augmentation in order to improve the performance of an AI model, according to another embodiment. The AI computing system 300 of FIG. 3 includes a learnt data augmentation model 302, a backbone model 303, a neck model 304, and a head model 307. In the embodiment of FIG. 3, unlabeled input data 301 is initially provided to the learnt data augmentation model 302.

The learnt data augmentation model 302 performs learned data augmentation on the input data 301 to augment instances of the training data. Learnt data augmentation model 302 augments input data 301 by changing features of the input data 301 to generate augmented data for AI computing system 300. As an example, the unlabeled input data 301 may be images, and learnt data augmentation model 302 may augment the input images 301 by flipping each of the input images 180 degrees to generate flipped images. As another example, learnt data augmentation model 302 may change the size and/or the shape of the input images in input data 301 to generate altered images. Learnt data augmentation model 302 may then process the altered images along with the original images 301 to generate more data.

The backbone model 303 may be, for example, a pre-trained artificial neural network (ANN) or another type of AI model, including another type of machine learning algorithm. Backbone model 303 may be pre-trained with labeled data to perform a task with some accuracy, as disclosed herein for example with respect to FIG. 1, before performing the operations disclosed herein with respect to FIG. 3. Backbone model 303 processes the augmented data generated by learnt data augmentation model 302 and/or the input data 301 to generate an output that is provided to neck model 304.

In some embodiments, neck model 304 is one or more ANNs. Upon instantiation of a new class or a new class cluster, neck model 304 generates and initializes a new ANN that learns the features specific to that new class or new class cluster. The output of the backbone model 303 is provided to the neck model 304 as input data.

During unsupervised learning, two or more of the ANNs in the neck model 304 process the output of the backbone model 303 in parallel. The ANNs in neck model 304 compete against each other based on an unsupervised score. The winning ANN of this competition claims the given input and may learn the encoded features of that input as its own class. The winning ANN in the neck model 304 processes the output of the backbone model 303 using few shot learning techniques to generate an output. The output of the winning ANN in neck model 304 may be compared to a correct label at operation 306 to generate a loss 308. The loss 308 may indicate an inaccuracy in the input received from the backbone model 303. The result of the comparison in operation 306 may be used to adapt learning features of the neck model 304 in operation 309. For example, the loss 308 may be used to adjust the weights of the winning ANN and/or optional thresholds of the winning ANN in neck model 304.

Head model 307 may be any type of AI model, including any type of machine learning algorithm. The output generated by one or more of the ANNs in the neck model 304 may be provided to adapt learning features of head model 307. For example, an output generated by one or more of the ANNs in the neck model 304 may be provided as imprinting weights 305 for one or more nodes of an ANN in head model 307. As another example, outputs generated by one or more of the ANNs in the neck model 304 may be used to adjust the weights and/or thresholds associated with nodes of the ANN in head model 307. The head model 307 performs an AI task, such as classification, detection, segmentation, etc. using the output of the neck model 304. The head model 307 may or may not have been pre-trained with labeled data.

FIG. 4 is a flow diagram for an artificial intelligence (AI) computing system 400 that includes a backbone model, a teacher model, and a student model that learns from the teacher model, according to another embodiment. AI computing system 400 includes a backbone model 404, a teacher model 411, and a student model 421. The backbone model 404, the teacher model 411, and the student model 421 may be any types of AI models, including any types of machine learning algorithms. As examples, one, two, or all three of the backbone model 404, the teacher model 411, and the student model 421 may include artificial neural networks (ANNs). According to a specific example, each of the backbone model 404, the teacher model 411, and the student model 421 includes an ANN.

In the embodiment of FIG. 4, a portion of a set of raw data 401 is classified with labels to generate a labeled data set 403. This portion of the raw data 401 may, for example, be labeled by one or more people. The remainder of the raw data 401 is provided as an unlabeled data set 402. Because labeling a large set of raw data may be costly and time consuming, in some embodiments, only a small portion of the raw data 401 may be labeled to generate labeled data set 403, and the majority of the raw data 401 may be provided as unlabeled data set 402.

In some embodiments, the model (e.g., an ANN) in the backbone model 404 is initially trained with the labeled data in data set 403 during a supervised learning process to perform a task with some accuracy. The backbone model 404 processes the labeled data in data set 403 to generate an output 405. The input data set to the backbone model 404 may be, for example, a tuple that contains an input (e.g., an image) and an expected output (e.g., ground truth). If, for example, the backbone model 404 is performing a classification task, the input to the machine learning model in backbone model 404 is a pair of an image of an object and a label in text identifying the object.

The backbone model 404 may be trained using supervised learning techniques, for example, by determining the difference between the output 405 of the backbone model 404 and the ground truth (illustrated by arrow 430). The ground truth 430 is identified by labels associated with the labeled data set 403 that was provided to backbone model 404. In operation 406, the output 405 of the backbone model 404 is compared with the ground truth 430 to generate an error 407. The backbone model 404 then uses the error 407 to adjust the weights and/or thresholds of the backbone model 404 according to a learning rule. Successive adjustments to the weights and/or thresholds cause the backbone model 404 to produce output data 405 that is increasingly similar to the ground truth 430 during many iterations of the supervising learning process.

After the backbone model 404 has been trained using the labeled data set 403 as described above, the pre-trained backbone model 404 then processes the data in the unlabeled data set 402 to generate output data 408 that is provided as an input to the teacher model 411. The output data 408 may, for example, include an identification of one or more features of the unlabeled data set 402 or one or more classifications of the unlabeled data set 402.

The teacher model 411 then processes the data 408 output by the backbone model 404 (e.g., using an ANN) to generate an output 412. The teacher model 411 may, for example, perform a semi-supervised or unsupervised learning procedure on the data 408 to generate output 412. The teacher model 411 may perform many iterations of the self-supervised or unsupervised learning procedure to improve the accuracy of the output 412 as described herein with respect to FIGS. 1 and 2 in this embodiment. As an example, the teacher model 411 may include an autoencoder that processes data 408 to generate output 412. The autoencoder may include an encoder and a decoder. The encoder maps the data 408 to a latent representation 413 that represents features of the data 408 that can be used by the decoder to accurately reconstruct the data 408 as output 412. The decoder in the autoencoder maps the latent representation 413 of data 408 generated by the encoder to the output 412. The autoencoder causes the output 412 to be a reconstruction of the data 408 that is as close as possible to the original data 408 received from backbone model 404. As a more specific example, the autoencoder in the teacher model 411 may be a variational autoencoder (VAE) that generates a disentangled latent object representation 413 having a continuous latent distribution (i.e., interpretable latents).

In operation 414, a pre-processing procedure performs learned data augmentation on the latent representation 413 generated by teacher model 411. The learned data augmentation performed on the latent representation 413 in operation 414 may, for example, involve modifying the unlabeled data set 402 and/or the labeled data set 403 using features of the latent representation 413 to increase the amount of input data 415 provided to the pre-trained backbone model 404.

According to another embodiment, the data augmentation procedure performed in operation 414 may create additional data using the existing data in the unlabeled data set 402. The additional data may be provided in areas of confusion in the latent representation 413 (e.g., areas of class overlap in the latent representation 413). As a specific example that is not intended to be limiting, the unlabeled input data set 402 may include images. If the input data set 402 includes images, one or more of the images may be flipped 180 degrees to generate one or more flipped images in operation 414. As another example, the size and/or the shape of images in unlabeled data set 402 may be changed in operation 414 to generate altered images. The flipped and/or altered images are then provided with the unlabeled data set 402 and/or the labeled data set 403 as a revised input data set 415 to the input of teacher model 411. The teacher model 411 then processes this revised data set 415 to generate a revised latent representation 413 and a revised output 412 using the revised latent representation 413. Alternatively, the backbone model 404 may process the revised input data set 415 to generate a revised output 408 that is provided to an input of teacher model 411 for re-processing to generate a revised latent representation 413 and a revised output 412. This embodiment may increase separation of the classes that overlap in the latent representation 413 prior to the data augmentation operation 414. This embodiment may be used instead of, or in addition to, the other embodiments of operation 414.

In some embodiments, the output 412 of the teacher model 411 may be provided to a head model (not shown) that processes the data in output 412 to generate an output. The head model may be, for example, an ANN that has been pre-trained using the labeled data set 403, as described above with respect to training backbone model 404, before processing the data in output 412. The output of the head model may be, for example, a prediction of a feature of the unlabeled input data set 402.

After the teacher model 411 performs the self-supervised or unsupervised learning procedure described above, and the data augmentation procedure performed in operation 414 has been completed, the backbone model 404 may process the unlabeled data set 402 and/or the revised data 415 (e.g., using an ANN) to generate an output 420 that is provided to an input of the student model 421. The student model 421 may have the same model architecture as the teacher model 411 or the same model architecture as the backbone model 404. Alternatively, the student model 421 may have a different model architecture than the teacher model 411 or the backbone model 404. The student model 421 may be, for example, an ANN or another type of AI system.

The student model 421 processes the data in output 420 received from the backbone model 404 to generate an output 422 (e.g., using an ANN). The output 422 may, for example, include an identification or prediction of a feature in the unlabeled data set 402 and/or in labeled data set 403. In operation 423, the output 422 of the student model 421 is compared to the output 412 of the teacher model 411 to generate a difference. The output 412 may also be an identification or prediction of a feature in the data set represented by input 408 or 415. The difference between the outputs 412 and 422 identified in operation 423 is used to generate values 424 that can be used to adapt learning features of the student model 421. The values 424 are provided to the student model 421. The values 424 may be used, for example, to change some or all of the weights and/or thresholds in an ANN in the student model 421.

As another example, the values 424 may be used to determine which of the nodes and their associated weights in the ANN in student model 421 to eliminate. In this example, the student model 421 may become smaller in each iteration of processing data 420 to generate output 422 as nodes and their associated weights are eliminated from the student model 421. Eliminating unnecessary nodes from an ANN may improve the accuracy of the output of the ANN and can also make deployment of the ANN faster as node elimination also reduces the amount of computation that is required. The values 424 may be used to eliminate nodes and their associated weights in the ANN in student model 421, in addition to, or instead of, modifying weights in the ANN. In some embodiments, the student model 421 is able to generate an output 422 that has a more accurate identification or prediction of a feature in the unlabeled data set 402 than the prediction or identification of the feature generated by teacher model 411 in output 412.

As discussed above, a labeled test data set is typically used to determine the performance accuracy of an AI model. However, labeled test data may not be available or may be too expensive to obtain to train an ANN. Additionally, conventional AI models, including few-shot networks, commonly utilize non- normalized internal latent features trained through gradient descent with no normalization constraint until the output layers. Using non-normalized features can facilitate training the network, but makes visualizing and interpreting the features more difficult.

According to some embodiments disclosed herein, an AI model having an ANN can build latent representations or features of input data (e.g., images) that are constrained (e.g., normalized) onto a hypersphere using dimensionality reduction techniques. The dimensionality reduction techniques transform the input data from a high-dimensional space into a low-dimensional space on a hypersphere so that the low-dimensional representation retains important and meaningful properties of the input data.

These embodiments may enable vector distances to be computed utilizing angle derived measures (e.g., cosine distances) between vectors generated by the ANN, rather than using a p-norm derived metric (e.g., Euclidean distance). As examples, the lengths of the vectors generated by the ANN may represent a degree of confidence that the input data (e.g., images) to the ANN have been classified correctly in classes defined by labeled or pretrained data, and the angle of each of the vectors relative to one or more labeled vectors may indicate classifications for the input data. The vector distances may indicate, for example, other input data (e.g., images) that have been grouped into the same class. Furthermore, the angles between the vectors allow the ANN to perform few-shot learning with higher accuracy.

In these embodiments, the architecture of the ANN uses normalized latent representations to represent object features on a hypersphere. The latent representations may be directly constrained through normalization or approximated through a learning process. By utilizing latent representations of object features that are constrained to a hypersphere, the vector length may be reserved to represent confidence of the ANN model, while not affecting the ability of the ANN to cluster inputs into distinct class regions. In these embodiments, a hypersphere refers to the set of points that is at a constant distance from a given point at its center.

In these embodiments, constraining the latent representations to a hypersphere and computing distances between the vectors with angle derived measures (e.g., cosine distances) may capture features of the latent representations that are not captured by Euclidian distances determined using a t-distributed stochastic neighbor embedding (t-SNE) algorithm. By constraining the latent representations of the ANN to a low dimension hypersphere (e.g., having 2 or 3 dimensions), the latent representations can also be visualized.

By using embeddings and model distributions fit to hyper-spherical data on the latent object representations, each input into the artificial neural network (ANN) can be visualized and fit to a class distribution in order to accurately determine the associated model inference accuracy that would be obtained from a cosine classifier classification head on a given distribution of test data by computing the overlap between class distributions in the feature embedding space.

The latent object representations generated by the ANN that are constrained to the hypersphere are the starting point for a visualization technique. This visualization technique may, for example, use von Mises-Fisher (VMF) distributions to fit class clusters, using a VMF-SNE fit, where SNE refers to a stochastic neighbor embedding machine learning algorithm. VMF is a probability distribution on a sphere. This technique may replace the t-SNE Gaussian distribution model with VMF distributions. This visualization may, e.g., be viewed directly by human users utilizing a graphical user interface (GUI) displaying the first 3 dimensions of the data on a sphere. Optionally, class distributions may be fit and used to compute class overlap in the embedded spherical space. This overlap can be used to approximate the accuracy of the AI model given only a few labeled instances of each class.

By constraining the latent representations generated by an ANN to a hypersphere to generate a visualization of the data, inaccuracies in the output of the ANN can be more easily identified using the visualization. For example, the visualization of the data can be used to quickly visualize confusion regions where 2 images overlap in the latent representation mapped on the hypersphere, such that the confusion regions can be reported directly to a user. After inaccuracies have been identified in the output of the ANN using the visualization on the hypersphere, additional data can be provided to the ANN to improve the accuracy of the output of the ANN. The additional data can be selected to provide more information about the objects in the input data that resulted in the inaccuracies. The additional data can be generated, for example, using one or more of the data augmentation techniques disclosed herein with respect to FIGS. 3-4.

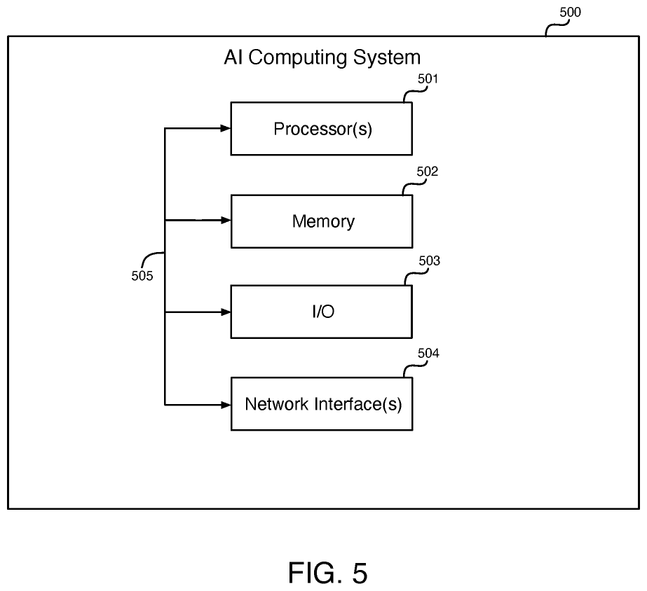

FIG. 5 illustrates an artificial intelligence (AI) computing system 500 that can implement various embodiments disclosed herein, for example, with respect to any one or more of FIGS. 1-4. AI computing system 500 includes one or more processors 501, memory 502 that includes one or more memory circuits or memory devices, one or more input/output (I/O) devices 503, one or more network interface devices 504, and one or more busses 505. AI system 500 may be housed in one computing device or in multiple computing devices. AI system 500 may, for example, be in one or more server computers. AI system 500 may, for example, be a distributed computing environment that has several computers communicating with each other. Two or more of the computers in the distributed computing environment may, for example, be located at a single location (e.g., a data center) and in communication with each other through one or more local area networks. Two or more of the computers in the distributed computing environment may be in multiple locations (e.g., multiple data centers) that are in communication with each other through a wide area network.

The one or more processors 501 may include one or more microprocessors or central processing units (CPUs), programmable logic devices, graphics processing units (GPUs), field programable gate arrays (FPGAs), or application specific integrated circuits (ASICs). Processors 501 may, for example, include an array of GPUs. The memory 502 may include any type of memory technology including, for example, random access memory (RAM) storage, read only memory (ROM) storage, non-volatile memory such as flash storage, magnetic disc storage, magnetic tape storage, etc. The one or more I/O devices 503 may include any types of devices configured to provide output to a user or to receive input from a user, such as a video monitor or display, a keyboard, a keypad, a mouse, a touch pad or panel, a pointing device, a microphone, a speaker, a camera, a scanner, or a printer. The one or more network interfaces 504 may include any devices capable of communicating with one or more computer networks, for example, switches, bridges, routers, modems, transceivers, hubs, cellphones, etc. Processors 501, memory 502, I/O devices 503, and network interfaces 504 communicate with each other through one or more busses 505. In some embodiments, AI system 500 also includes other devices and components that are not shown in FIG. 5.

AI system 500 can implement the various embodiments disclosed herein with respect to FIGS. 1-4. For example, AI system 500 can run one or more of backbone model 101 of FIGS. 1-2, the operations of FIGS. 1-2, the neck model 105 of FIGS. 1-2, the learnt data augmentation model 302 of FIG. 3, backbone model 303 of FIG. 3, neck model 304 of FIG. 3, head model 307 of FIG. 3, backbone model 404 of FIG. 4, teacher model 411 of FIG. 4, student model 421 of FIG. 4, and/or the operations of FIG. 4.

In general, software, including any of the AI models disclosed herein, and data may be stored in non-transitory computer-readable storage media (e.g., tangible computer readable storage media). Non-transitory computer-readable storage media provides continuous storage for data, as opposed to media that only transmits propagating electrical signals, such as wires. Software may sometimes be referred to as program instructions, instructions, or code. The non-transitory computer-readable storage media may include voltage memory circuits, non-volatile memory circuits, one or more hard drives (e.g., magnetic drives or solid state drives), one or more removable flash drives or other removable media, compact discs (CDs), digital versatile discs (DVDs), Blu-ray discs (BDs), other optical media, floppy disks, tapes, or any other suitable memory or storage device(s).

The following examples pertain to further embodiments. Example 1 is a computing system comprising: at least one processor that executes program instructions; and memory for storing the program instructions, wherein the program instructions comprise a first artificial neural network (ANN), wherein the first ANN is configured to receive input data from a second ANN that has been pre-trained with labeled data and that generated the input data by processing unlabeled data, map the input data to a latent representation of the input data, and map the latent representation of the input data to a reconstruction of the input data, wherein the computing system adapts learning features of an artificial intelligence model based on an output of the first ANN.

In Example 2, the computing system of Example 1 may optionally include, wherein the computing system adapts the learning features by adjusting weights associated with nodes of the second ANN in the artificial intelligence model based on the output of the first ANN.

In Example 3, the computing system of Example 1 or 2 may optionally include, wherein the computing system adapts the learning features by removing nodes from the second ANN in the artificial intelligence model based on the output of the first ANN.

In Example 4, the computing system of any one of Examples 1 to 3 may optionally include, wherein the computing system adapts the learning features by adjusting thresholds of the second ANN in the artificial intelligence model based on the output of the first ANN.

In Example 5, the computing system of any one of Examples 1 to 4 may optionally include, wherein the computing system adapts the learning features of the artificial intelligence model based on the latent representation of the input data.

In Example 6, the computing system of any one of Examples 1 to 5 may optionally include, wherein the computing system adapts the learning features of the artificial intelligence model based on the reconstruction of the input data.

In Example 7, the computing system of any one of Examples 1 to 6 may optionally include, wherein the computing system is configured to run a plurality of artificial neural networks that process the input data in parallel to generate a score, and wherein the computing system selects each of the plurality of artificial neural networks to learn encoded features of the input data as a class.

In Example 8, the computing system of any one of Examples 1 to 7 may optionally include, wherein the computing system uses the output of the first ANN to adapt the learning features in the second ANN.

In Example 9, the computing system of any one of Examples 1 to 7 may optionally include, wherein the computing system uses the output of the first ANN to adapt the learning features in a third ANN in the artificial intelligence model.

In Example 10, the computing system of any one of Examples 1 to 9 may optionally include, wherein the computing system adapts the learning features of the artificial intelligence model based on a comparison between the reconstruction of the input data generated by the first ANN and an output of the artificial intelligence model.

In Example 11, the computing system of any one of Examples 1 to 10 may optionally include, wherein the computing system performs data augmentation on the input data by changing features of the input data to generate additional data for the first ANN to process to generate the latent representation.

In Example 12, the computing system of any one of Examples 1 to 11 may optionally include, wherein the computing system performs data augmentation on the latent representation to generate additional input data that is provided to the first ANN, and wherein the first ANN generates a revised latent representation based on the additional input data.

In Example 13, the computing system of any one of Examples 1 to 12 may optionally include, wherein the first ANN maps the input data to a continuous disentangled latent distribution.

In Example 14, the computing system of Example 13 may optionally include, wherein the computing system performs data augmentation by generating samples in an area where at least two classes overlap in the continuous disentangled latent distribution, wherein the computing system provides the samples to the first ANN as additional input data, and wherein the first ANN generates a revised continuous disentangled latent distribution based at least in part on the additional input data.

In Example 15, the computing system of any one of Examples 1 to 14 may optionally include, wherein the computing system is configured to run a third ANN that maps additional input data to an additional latent representation, and wherein the artificial intelligence model processes an output of the third ANN to generate the input data for the first ANN.

In Example 16, the computing system of any one of Examples 1 to 15 may optionally include, wherein the input data comprises images, and wherein the computing system uses the output of the first ANN to adapt the learning features of the artificial intelligence model to identify classes in the images.

In Example 17, the computing system of Example 16 may optionally include, wherein the input data that the first ANN maps to the latent representation comprises a prediction generated by the artificial intelligence model by processing the images.

In Example 18, the computing system of Example 17 may optionally include, wherein the output of the first ANN indicates a predicted error in the prediction generated by the artificial intelligence model.

In Example 19, the computing system of any one of Examples 1-18 may optionally include, wherein the first ANN comprises an autoencoder.

Example 20 is a method for operating an artificial intelligence computing system on at least one processor, the method comprising: generating a prediction by processing unlabeled data with a first artificial neural network that has been pre-trained with labeled data; providing the prediction and the unlabeled data from the first artificial neural network to a second artificial neural network as input data; mapping the input data to a latent representation of the input data; mapping the latent representation of the input data to a reconstruction of the input data; and adapting learning features of an artificial intelligence model based on an output of the second artificial neural network.

In Example 21, the method of Example 20 may optionally include, wherein adapting the learning features of the artificial intelligence model comprises adapting the learning features by adjusting weights associated with nodes of the first artificial neural network in the artificial intelligence model based on the output of the second artificial neural network.

In Example 22, the method of Example 20 or 21 may optionally include, wherein adapting the learning features of the artificial intelligence model comprises adapting the learning features by removing nodes from the first artificial neural network in the artificial intelligence model based on the output of the second artificial neural network.

In Example 23, the method of any one of Examples 20-22 may optionally include, wherein adapting the learning features of the artificial intelligence model comprises adapting the learning features by adjusting thresholds of the first artificial neural network in the artificial intelligence model based on the output of the second artificial neural network.

In Example 24, the method of any one of Examples 20-23 may optionally include, wherein adapting the learning features of the artificial intelligence model comprises adapting the learning features of the artificial intelligence model based on the latent representation of the input data.

In Example 25, the method of any one of Examples 20-24 may further comprise: performing data augmentation on the input data by changing features of the input data to generate additional data for the second artificial neural network to process to generate the latent representation.

Example 26 is a non-transitory computer-readable storage medium comprising instructions stored thereon for causing an artificial intelligence computing system to execute a method, the method comprising: generating a prediction by processing unlabeled data with a first artificial neural network that has been pre-trained with labeled data; providing the prediction and the unlabeled data from the first artificial neural network to a second artificial neural network as input data; mapping the input data to a latent representation of the input data; mapping the latent representation of the input data to a reconstruction of the input data; and adapting learning features of an artificial intelligence model based on an output of the second artificial neural network.

In Example 27, the non-transitory computer-readable storage medium of Example 26 may optionally include, wherein adapting the learning features of the artificial intelligence model comprises adapting the learning features of the artificial intelligence model based on the reconstruction of the input data.

In Example 28, the non-transitory computer-readable storage medium of any one of Examples 26-27 may further comprise: performing data augmentation on the latent representation to generate additional input data that is provided to the second artificial neural network; and generating a revised latent representation based on the additional input data using the second artificial neural network.

In Example 29, the non-transitory computer-readable storage medium of any one of Examples 26-28 may further comprise: running a third artificial neural network that maps additional input data to an additional latent representation; and processing an output of the third artificial neural network to generate the input data for the second artificial neural network using the artificial intelligence model.

In Example 30, the non-transitory computer-readable storage medium of any one of Examples 26-29 may optionally include, wherein the second artificial neural network comprises an autoencoder.

The foregoing description of the exemplary embodiments of the present invention has been presented for the purpose of illustration. The foregoing description is not intended to be exhaustive or to limit the present invention to the examples disclosed herein. In some instances, features of the present invention can be employed without a corresponding use of other features as set forth. Many modifications, substitutions, and variations are possible in light of the above teachings, without departing from the scope of the present invention.

What is claimed is:

1. A computing system comprising:
at least one processor that executes program instructions; and
memory for storing the program instructions, wherein the program instructions comprise a first artificial neural network (ANN),
wherein the first ANN is configured to receive input data from a second ANN that has been pre-trained with labeled data and that generated the input data by processing unlabeled data, map the input data to a latent representation of the input data, and map the latent representation of the input data to a reconstruction of the input data,
wherein the computing system adapts learning features of an artificial intelligence model based on an output of the first ANN.

2. The computing system of claim 1, wherein the computing system adapts the learning features by adjusting weights associated with nodes of the second ANN in the artificial intelligence model based on the output of the first ANN.

3. The computing system of claim 1, wherein the computing system adapts the learning features by removing nodes from the second ANN in the artificial intelligence model based on the output of the first ANN.

4. The computing system of claim 1, wherein the computing system adapts the learning features by adjusting thresholds of the second ANN in the artificial intelligence model based on the output of the first ANN.

5. The computing system of claim 1, wherein the computing system adapts the learning features of the artificial intelligence model based on the latent representation of the input data.

6. The computing system of claim 1, wherein the computing system adapts the learning features of the artificial intelligence model based on the reconstruction of the input data.

7. The computing system of claim 1, wherein the computing system is configured to run a plurality of artificial neural networks that process the input data in parallel to generate a score, and wherein the computing system selects each of the plurality of artificial neural networks to learn encoded features of the input data as a class.

8. The computing system of claim 1, wherein the computing system uses the output of the first ANN to adapt the learning features in the second ANN.

9. The computing system of claim 1, wherein the computing system uses the output of the first ANN to adapt the learning features in a third ANN in the artificial intelligence model.

10. The computing system of claim 1, wherein the computing system adapts the learning features of the artificial intelligence model based on a comparison between the reconstruction of the input data generated by the first ANN and an output of the artificial intelligence model.

11. The computing system of claim 1, wherein the computing system performs data augmentation on the input data by changing features of the input data to generate additional data for the first ANN to process to generate the latent representation.

12. The computing system of claim 1, wherein the computing system performs data augmentation on the latent representation to generate additional input data that is provided to the first ANN, and wherein the first ANN generates a revised latent representation based on the additional input data.

13. The computing system of claim 1, wherein the first ANN maps the input data to a continuous disentangled latent distribution.

14. The computing system of claim 13, wherein the computing system performs data augmentation by generating samples in an area where at least two classes overlap in the continuous disentangled latent distribution, wherein the computing system provides the samples to the first ANN as additional input data, and wherein the first ANN generates a revised continuous disentangled latent distribution based at least in part on the additional input data.

15. The computing system of claim 1, wherein the computing system is configured to run a third ANN that maps additional input data to an additional latent representation, and wherein the artificial intelligence model processes an output of the third ANN to generate the input data for the first ANN.

16. The computing system of claim 1, wherein the input data comprises images, and wherein the computing system uses the output of the first ANN to adapt the learning features of the artificial intelligence model to identify classes in the images.

17. The computing system of claim 16, wherein the input data that the first ANN maps to the latent representation comprises a prediction generated by the artificial intelligence model by processing the images.

18. The computing system of claim 17, wherein the output of the first ANN indicates a predicted error in the prediction generated by the artificial intelligence model.

19. The computing system of claim 1, wherein the first ANN comprises an autoencoder.

20. A method for operating a computing system on at least one processor, the method comprising:
generating a prediction by processing unlabeled data with a first artificial neural network that has been pre-trained with labeled data;
providing the prediction and the unlabeled data from the first artificial neural network to a second artificial neural network as input data;
mapping the input data to a latent representation of the input data;
mapping the latent representation of the input data to a reconstruction of the input data; and
adapting learning features of an artificial intelligence model based on an output of the second artificial neural network.

21. The method of claim 20, wherein adapting the learning features of the artificial intelligence model comprises adapting the learning features by adjusting weights associated with nodes of the first artificial neural network in the artificial intelligence model based on the output of the second artificial neural network.

22. The method of claim 20, wherein adapting the learning features of the artificial intelligence model comprises adapting the learning features by removing nodes from the first artificial neural network in the artificial intelligence model based on the output of the second artificial neural network.

23. The method of claim 20, wherein adapting the learning features of the artificial intelligence model comprises adapting the learning features by adjusting thresholds of the first artificial neural network in the artificial intelligence model based on the output of the second artificial neural network.

24. The method of claim 20, wherein adapting the learning features of the artificial intelligence model comprises adapting the learning features of the artificial intelligence model based on the latent representation of the input data.

25. The method of claim 20 further comprising:
performing data augmentation on the input data by changing features of the input data to generate additional data for the second artificial neural network to process to generate the latent representation.

26. A non-transitory computer-readable storage medium comprising instructions stored thereon for causing an artificial intelligence computing system to execute a method, the method comprising:
generating a prediction by processing unlabeled data with a first artificial neural network that has been pre-trained with labeled data;
providing the prediction and the unlabeled data from the first artificial neural network to a second artificial neural network as input data;
mapping the input data to a latent representation of the input data;
mapping the latent representation of the input data to a reconstruction of the input data; and
adapting learning features of an artificial intelligence model based on an output of the second artificial neural network.

27. The non-transitory computer-readable storage medium of claim 26, wherein adapting the learning features of the artificial intelligence model comprises adapting the learning features of the artificial intelligence model based on the reconstruction of the input data.

28. The non-transitory computer-readable storage medium of claim 26 further comprising:
performing data augmentation on the latent representation to generate additional input data that is provided to the second artificial neural network; and
generating a revised latent representation based on the additional input data using the second artificial neural network.

29. The non-transitory computer-readable storage medium of claim 26 further comprising:
running a third artificial neural network that maps additional input data to an additional latent representation; and
processing an output of the third artificial neural network to generate the input data for the second artificial neural network using the artificial intelligence model.

30. The non-transitory computer-readable storage medium of claim 26, wherein the second artificial neural network comprises an autoencoder.
